(19) United States
(12) Patent Application Publication
(10) Pub. No.: US 2024/0256347 A1
(43) Pub. Date: Aug. 1, 2024

(54) APPARATUS AND METHOD FOR DETECTION, TRIAGING AND REMEDIATION OF UNRELIABLE MESSAGE EXECUTION IN A MULTI-TENANT RUNTIME

(71) Applicant: Salesforce, Inc., San Francisco, CA (US)

(72) Inventors: Brian Toal, Danville, CA (US); Ram Narsimhamurty Mantri Pragada, Hyderabad (IN); Amit Kumar, Fremont, CA (US)

(73) Assignee: Salesforce, Inc., San Francisco, CA (US)

(21) Appl. No.: 18/162,706

(22) Filed: Jan. 31, 2023

(51) Int. Cl. G06F 9/50; G06F 9/54

(52) U.S. Cl. CPC G06F 9/5033; G06F 9/546

(57) ABSTRACT

Apparatus and method for detection, triaging and remediation of unreliable message execution in a multi-entity (e.g., multi-tenant) runtime. The described system solves this reliability issues of message handlers in a multi-tenant distributed application runtime by automated metering, detecting, triaging, remediating, and notifying stakeholders, in a proactive way. Doing so increases system availability and improves customer experience, as we continue to increase the scale of our services across the planet. As services are scaled across the world, the implementations described provide the benefit of reducing total cost-of-ownership, by reducing the linear operational cost that would be needed if humans had to deal with message processing service issues.

### TECHNICAL FIELD

One or more implementations relate to the field of computer systems for managing services; and more specifically, to a system and method for detection, triaging, and remediation of unreliable message execution in a multi-tenant runtime.

### BACKGROUND ART

Some cloud-based architectures rely on message processing subsystems which encapsulate work in messages passed between service entities. These message processing subsystems allow platform and product capabilities to execute work asynchronously, allowing for higher availability and scalability.

To accommodate the needs of different applications, the message processing subsystem supports thousands of unique message types and processes hundreds of billions of messages a month across tenants in a multi-tenant application runtime. A message represents a single instance of a message type. A message type has a schema, which describes the attributes that represent the message encoding. A message type has a single message handler that provides the processing logic for a passed message. A single message corresponds to a single tenant. In a multi-tenant platform, some message types/handlers are created to enable specific product capabilities, and the behavior of some message types can be extended by customers' custom business logic. As a result, the workload characteristics across message types can swing wildly; some message types are heavily CPU bound, others are heavily IO bound, and some a combination of both. Finally, a fixed set of message executors (threads), across the distributed multi-tenant runtime cluster are responsible for message processing, and are given messages to execute. The message processing framework is responsible for delegating each message to the corresponding message handler which will execute the code on the thread.

When a particular degree of message handler execution saturates message execution threads, overall throughput of message processing degrades. This impacts the processing of all mutually exclusive message types, for all tenants that share the runtime. This will ultimately lead to an overall cascading impact to the multi-tenant runtime, reducing availability of not only message processing but also of all the other capabilities that execute in the same multi-tenant runtime due to critical resources being saturated. It's possible that the issue corresponds to a single message type and single tenant combination, or it's possible that the issue corresponds to a single message type across all tenants, for example when a single handler becomes long running, due to inefficient code or fragile integration with other services.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 illustrates one implementation of a system for tracking resource utilization based on message type and automatically taking corrective action;

FIG. 2 illustrates a method for tracking resource utilization based on message type;

FIG. 3A is a block diagram illustrating an electronic device 1800 according to some example implementations; and

FIG. 3B is a block diagram of a deployment environment according to some example implementations.

### DETAILED DESCRIPTION

Embodiments of the invention address the problems described above by performing all or a subset of the following operations:
1. Track top-level critical resource utilization. Resource utilization tracking is performed not only for the DB CPU but also for dozens of other critical resource types (e.g., the App CPU, JVM gc, DB IOPS, etc).
2. Coarse grained metering of the utilization of mission critical resources (app CPU, RDBMS cpu, etc) that message handlers. Also, fine-grained resource metering by message type and tenant over a period of time. In the case where a tenant has saturated database (DB) connection usage (indicated by the coarse grained db metric), the metering engine can be queried to determine the top message type(s) and potentially the tenant(s) dominating the DB resource to build the suspect list.
3. Detect when top-level resource utilization is in an unhealthy state. Various strategies are used for detection (predictive based on ML and/or rule based). The buffer storing the metering data can be queried to pinpoint the culprit message type(s) and associated tenants.
4. Use the metering data to pinpoint the message type abusing the critical resource that is in an unhealthy state. The query response returns the message type, tenant and the identity of the corresponding critical resource which is being saturated.
5. Collect observability events in the form of profiling, tracing, logging, etc that are included in the feedback data provided to the message type owner. This allows the internal team that owns the message handler, or the tenant that has extended the behavior of a platform-based handler to understand the reasons underlying the handler's poor behavior.
6. Apply the appropriate remediation actions on the culprit message type. For example, when messages of a tenant's message type are dominating the DB CPU (the critical resource type), those tenant-specific messages may be blocked on enqueue and/or throttled depending on the encoded remediation action for this issue. In-flight message handlers may be terminated so that the message execution threads can be freed up to continue processing messages.
7. Publish events and observability data to subscribers who are interested to know that their message type has been remediated. Send the message type owner team a notification that their handers have been blocked/throttled and the reason(s) why, as well as observability data that includes the DB statements and call stacks that saturated the DB CPU. In addition, the account executive for that tenant may be proactively notified.

The following description includes implementations for detecting over-utilization of the message processing executors or otherwise problematic use of resources by one or more message types by one or more tenants, pinpointing the message type and whether the issue is local to a single tenant or all tenants, and performing remediation operations to prevent resource degradation. These implementations solve the problem of poorly defined or implemented message types by metering resource utilization on the basis of message type and tenant, detecting when a critical resource is saturating, pinpointing which message type and tenant is the culprit, remediating problems with particular message types, and notifying message type owners. Remediation occurs in the form of throttling, suspension, and/or terminating in-flight messages. Doing so prevents a noisy message type from impacting the health of the overall multi-tenant runtime, thereby preserving availability. Finally, metadata associated with the message type can be used to identify the service team that owns the handler implementation. Feedback can then be provided in the form of an alert to the owner, along with the pertinent details including, by way of example and not limitation, the message type, number of message impacted, tenant ID, stack trace of the long running message, message duration, and message start time.

A “resource” is a functional component with a bounded capacity that is shared by different capabilities in the multi-tenant runtime, either serving OLTP requests or executing message handlers. The functional component depends on hardware (e.g., a CPU, memory) or by a combination of hardware and dependent services (RDBMS, distributed caches, etc). Some examples of resources include a processor/CPU, memory storage, memory bandwidth, and input/output (IO) bandwidth.

“Resource utilization” refers to a measured value or set of measured values which reflect the portion of the total capacity of a resource being used. For example, an 80% CPU utilization means that 80% of the total capacity of the CPU is being utilized and a 50% memory bandwidth utilization means that half of the total memory bandwidth is being utilized.

One implementation of the invention stores and analyzes resource utilization data associated with the processing of messages of each message type and tenant combination. Each message processed contains the fine-grained metering of how much of each dependent resource was consumed when the message was processed. In some embodiments, instrumentation is added on the message processing thread to capture a “before” and “after” snapshot of the resource meter, and the exact amount of resource utilization. This data, along with the tenant ID corresponding to the message type, are captured and pushed to a metrics sliding bufferFor example, the separate sets of resource utilization metrics (runtime CPU, memory allocation, DB time) may be organized based on message type and stored in memory (e.g., in a memory buffer or other data structure). As described further below, in some implementations, the resource utilization data may be analyzed to determine the portion of the total capacity of each resource consumed by each message type over a period of time.

One implementation also continually monitors the “health” of the coarse grained resources in the system based on resource utilization measurements. In some implementations, the “health” of a resource is based on specified resource utilization thresholds. If a resource reaches a specified threshold, the resource is determined to be in an “unhealthy” state and a sequence of operations may be triggered to determine whether any particular message types and corresponding tenant IDs are responsible for the threshold being reached. When a particular message type and tenant combination are clearly identified as consuming a significant proportion of the overall resource, this message type and tenant are marked as the culprit causing saturation. It is also possible that the aggregated volume of a tenant's message processing across many message types saturates a critical resource so the remediation action is applied at the tenant level rather than a system level (i.e., remediation is applied only to messages associated with the tenant, rather than the entire system platform). Next, a set of remediation actions may be automatically initiated to reduce utilization of the resource. Remediation actions include, by way of example and not limitation, terminating any inflight messages, throttling new messages from being executed, and blocking messages. The remediation action can happen for a specific message type or tenant, or in a more fine-grained way, by including both Tenant ID and message type, when available.

In one implementation, in response to detecting the utilization of a particular resource reaching a threshold, the associated metrics for each message type are accessed from memory and evaluated to determine whether the resource degradation is the result of one or more problematic message types. For example, if a CPU/compute resource reaches 90% utilization, one implementation evaluates the per-message type aggregated metrics to identify those message types which are consuming the largest portion of the CPU/compute resource. If the utilization of a particular message type is determined to be problematic (e.g., above a utilization threshold for this message type), then one or more remediation operations are triggered and/or the message type owner is notified. By way of example, and not limitation, the remediation operations may include throttling or dropping messages of the message type (e.g., by setting a maximum number of messages or maximum CPU/compute usage per unit of time).

Some implementations include processing messages across a distributed runtime cluster. As a result, detection, triaging and remediation is done in a distributed way. For example, in some implementations, distributed detection is accomplished by one instance in the cluster being elected as the detection and remediation leader. The detection leader runs on a duty cycle, executing every few seconds (configurable) and enumerates through all the coarse grained metrics, searching for unhealthy resources. If no resource is determined to be unhealthy, the duty cycle completes. However when a top level resource is determined to be unhealthy, the detection leader enters into a culprit detection routine. The leader leverages service discovery to get the list of all the runtime instances operating in the cluster and acquires the per-instance message metering state. The leader then aggregates the set of per instance message metering states to create a cluster wide view. Finally, the leader runs one or more queries against the cluster wide metered view to find (1) the culprit message type and tenant combination; (2) the culprit message type regardless of tenant; and/or (3) the culprit tenant agnostic to message type. In some instances, the leader instance may perform all or a selected subset of these queries, depending on the circumstances (e.g., starting by identifying a culprit message type and then determining if a particular tenant can be implicated).

In some implementations, for the particular culprit identified, the detection leader will publish an event to a remediation manager which is configured with a set of scripts—i.e., playbooks that define the remediation steps to be taken in different circumstances. These playbooks may be unique to the classification of saturation (e.g., RDBMS, App CPU, etc). When the remediation manager is passed a remediation request which includes the resource that is saturated, the event time, the tenant, and the message type, the remediation manager then will find the appropriate playbook and start executing the remediation steps. Typically the playbook contains an iterative set of remediation actions that are applied incrementally. The least invasive remediation action is executed first, and the remediation manager waits a configurable amount of time for health to be restored before it executes a more invasive remediation action. Throughout the process, the remediation manager may continually probe the utilization level of the flagged unhealthy resource to determine if health has recovered. It does this for a configurable amount of time, before moving to the next remediation action. The remediation manager will continue to execute actions until health is restored. In the rare case where all remediation actions are exhausted, a notification is sent to one or more responsible humans (e.g., the tenant contact and/or other internal personnel).

The election of the application instance may be performed dynamically at startup of the cluster or during runtime. Alternatively, the instance may be elected manually (e.g., by an administrator) prior to startup or during runtime. The instance which is elected is sometimes referred to herein as the “elected instance.”

Regardless of how the elected instance is determined, when an instance detects that a resource has reached a utilization threshold, it communicates this information to the elected instance, which then performs the analysis using message type metrics from all instances in the cluster. In some implementations, all of the instances share a region in memory in which the message type metrics are stored, and therefore accessible to the elected instance. Alternatively, or in addition, the other instances may transmit or identify the memory location of their resource utilization metrics to the elected instance (e.g., transmitting address pointers to identify the storage locations).

The elected instance analyzes the per-message type utilization metrics to determine whether any particular message types and/or are over-utilizing a resource. The analysis may include an evaluation of the average per-message resource utilization for each message type. For example, a message type may be determined to be problematic if its messages are responsible for an inordinately large resource utilization compared to the expected utilization of such messages. The analysis may also be based on the relative number of messages of the message type processed during a period of time in view of the underlying purpose of the message type.

If a message type is determined to be over-utilizing a resource, then the elected instance determines one or more remediation operations to be performed. The elected instance transmits a message indicating these remediation operations to the other instances in the cluster. Each of the instances (including the elected instance) may then perform the specified remediation operations with respect to messages of the responsible message type. For example, messages of the problematic message type may be throttled to a maximum number of allowable messages within a quantum of time (e.g., no more than n messages per 0.1 s, 1 s, 10 s, etc). Once the throttling threshold has been reached within the time quantum, any new messages of this message type will be queued or dropped until a new time quantum is reached. Additional remediation actions can include blocking a message type and/or tenant combination.

In some implementations, the elected instance also transmits a notification to the message owner, identifying the problem with the message type or message type and a tenant combination and potentially including recommendations on how to resolve the problem with the message type (e.g., based on the particular resource being overused). In some implementations, the elected instance automatically initiates a tracing operation to trace execution of the code paths triggered by the problematic message type. The metrics generated by the tracing operation may indicate the time taken to process the various functions in the code path, so that the problematic portion(s) of the code path (e.g., those consuming more time than expected) can be isolated and patched. Thus, in these implementations, in addition to notifying the message owner, the elected instance may transmit the metrics collected via the tracing operation, potentially highlighting those portions of the code paths which are likely to be the source of the message type over-utilization.

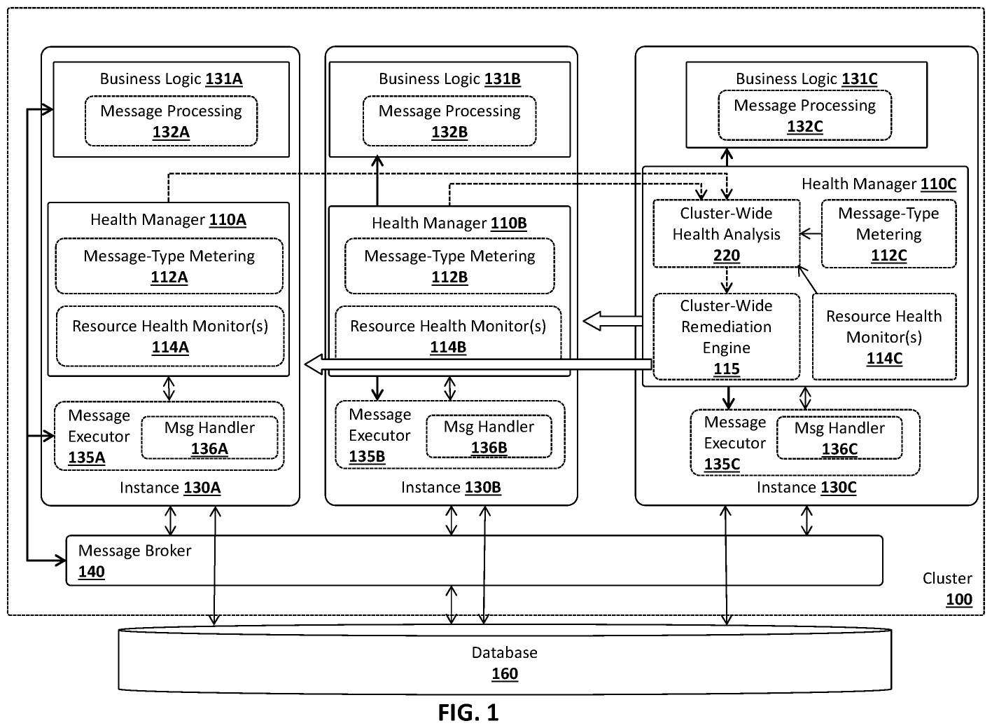

FIG. 1 illustrates one example of a cluster 100 with a plurality of instances 130A-C including business logic 131A-C with message processing logic 132A-C, respectively, for sending, receiving, and processing messages as described herein. Messages 101A may be generated by any entity external to the cluster 100 or within the cluster 100, including, but not limited to, the business logic 131A-C of the different instances 130A-C, respectively. The business logic 132A-C of the instances 130A-C, respectively, include application program code to perform work specified in the request messages and generate results, which are transmitted in response messages to the requestors.

A health manager 110A-C configured on each instance 130A-C includes message type metering logic 112A-C for metering resource usage by message type as described herein, and resource health monitors 114A-C, respectively, for monitoring the health of various resources, including “critical” resources required for the message executors 135A-C to perform the requested work.

In some implementations, messages are passed to and from message executors 135A-C of each instance 130A-C, respectively, via a message broker 140. For example, the message executors 135A-C may need to send request messages to other services to process the work specified in a request message. In these implementations, message handlers 136A-C associated with the message executors 135A-C, respectively, communicate with the message broker 140 to request incoming messages and write outgoing messages on behalf of the message executors 135A-C.

In some implementations, the message broker 140 queues messages in the database 140 and message handlers 136A-C of the message executors 135A-C (and potentially other messaging engines not shown) periodically poll the database 160 (e.g., via the message broker 140) to determine if any new messages are available for processing. If so, then the message broker 140 reads the requested messages from the database 160, provides it to the requesting message handlers, and sets one or more flags to indicate that the messages have been handled. The message executors 135A-C then provide the messages to the relevant business logic 131A-C (via corresponding message processing logic 132A-C). The business logic 131A-C performs the work indicated in the messages to generate results which are encapsulated in response messages, which may be passed through the message executors 135A-C and message broker 140.

In some implementations, a publish-subscribe mechanism is used for exchanging messages via the message broker 140. The message broker 140 publishes a message including a request and security information associated with the request to one or more logical channels. Messages published by the message broker 140 may be queued in the database 160. Any message handlers which subscribe to these logical channels (e.g., message handlers 136A-C) poll the database 160 to determine if any new messages associated with these logical channels are available. If so, the message handlers 136A-C retrieve the new messages from the database 160 via the message broker 140.

During these sequences of operations, the message-type metering logic 112A-C on each instance 130A-C, respectively, meters per-message type utilization metrics as described above and buffers these metrics in memory for a period of time (e.g., within a shared memory space). When one or more of the resource health monitors 114A-C detect that a particular resource utilization threshold has been reached, cluster-wide health analysis logic 220 on the elected instance 130C analyzes the per-message type utilization metrics to determine whether messages of any of the message types or message type and tenant combination are over-utilizing a resource. As mentioned, the analysis may include determining the average total per-message resource utilization for each message type and/or the relative number of messages of the message type processed during a period of time in view of the underlying purpose of the message type.

If a message type is determined to be over-utilizing a resource, then a cluster-wide remediation engine 115 on the elected instance 130C determines one or more remediation operations to be performed and transmits a message indicating these remediation operations to the other instances 130A-B in the cluster 100. Each of the instances 130A-C then implement the specified remediation actions with respect to messages of the responsible message type. For example, the health managers 110A-C may throttle messages of the problematic message type by, for example, limiting the number of messages within each time interval. Once the throttling threshold has been reached within a given time interval, any new messages of this message type will be queued or dropped until the next time interval.

In some implementations, the cluster-wide remediation engine 115 also transmits a notification to the message owner (not shown), identifying the problem with the message type and potentially including recommendations on how to resolve the problem with the message type (e.g., based on the particular resource being overused). In some implementations, the cluster-wide remediation engine 115 also initiates a tracing operation to trace execution of the code paths triggered by the problematic message type. The metrics generated by the tracing operation may indicate the time taken to process the various functions in the code path, so that the problematic portion(s) of the code path (e.g., those consuming more time than expected) can be isolated and patched by the message owner. Thus, in these implementations, in addition to notifying the message owner, the cluster-wide remediation engine 115 also transmits the metrics collected during the tracing operation, potentially highlighting those portions of the code paths which are likely to be the source of the message type problems.

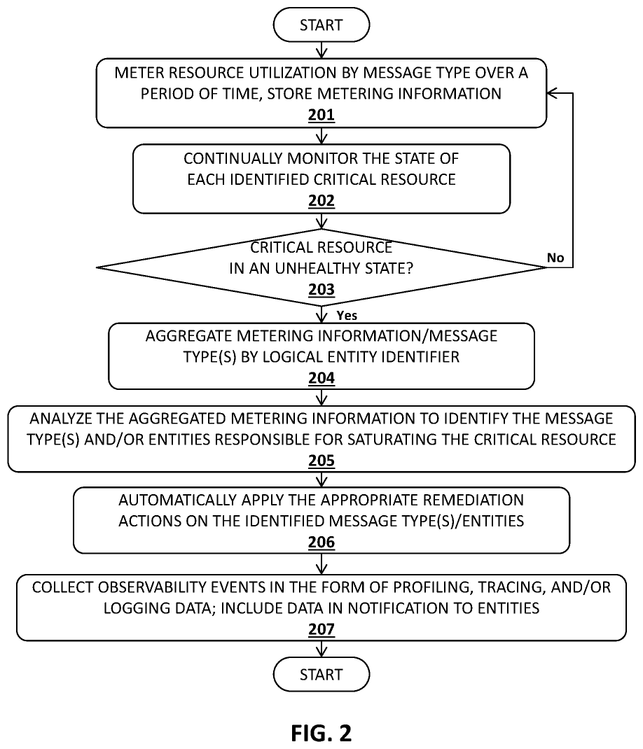

A method in accordance with one implementation is illustrated in FIG. 2. The method may be implemented on the various architectures described herein, but is not limited to any particular architecture.

At 201 resource utilization is metered by message type over a specified period of time and the metering information is stored. In some implementations, every message processed is metered, so the accounting captured by each metering engine is an aggregate view of all messages processed and corresponding resources consumed.

At 202, the state of each critical resource of a plurality of resources is continually monitored. As mentioned, monitoring may include reading or otherwise determining a current utilization value for each critical resource. Various types of critical resources may be monitored including high-level critical resources such as various forms of CPU/compute resources, memory resources, database resources, and IO resources.

One or more of the monitored critical resources may enter into an unhealthy state, detected at 203. As previously mentioned, the “unhealthy” state may be defined by utilization thresholds. When utilization of a particular resource exceeds an associated threshold, this may trigger operations to detect and correct the underlying problem.

At 204, the metering data is aggregated based on message type and/or logical entity identifiers (IDs) such as a tenant ID. For example, the metering data may be aggregated on a per-entity basis (e.g., a per-tenant basis) and/or a per-message type basis to indicate the number of messages of each message type attributed to different entities (such as tenants). At 205, the aggregated metering information is analyzed to identify the message type(s) and/or entities responsible for saturating the critical resource, causing it to be in an unhealthy state. For example, one or more message types which have the highest utilization of the resource and/or one or more responsible entities may be identified. Aggregating the metering data based on the responsible entity as well as message type provides a finer level of detail and allows individual entities responsible for saturating the critical resource to be identified and notified.

At 206, appropriate remediation actions are taken to reduce the impact of the message types on the resource. For example, messages of the message types may be throttled based on a maximum allowable resource utilization, a maximum number of messages, or other criteria for reducing resource usage by the message types. In some implementations, if the metering data indicates that the critical resource is being over-utilized by a particular entity, then the remediation action may only be applied to the messages associated with this entity (e.g., and not penalizing all entities because of the one entity causing the issue).

At 207, observability events are collected in the form of profiling, tracing, and/or logging to capture data related to processing messages of the message types. This data may indicate the portions of the program code associated with the messages which are causing the over-utilization of the resource. Thus, when the message type owner is notified of the over-utilization problem associated with the message type, the data may be included in the notification to aid the message owner in troubleshooting the message type.

In some implementations, the operations illustrated in FIG. 2 are all performed automatically within a runtime environment, without the need for user intervention.

### Example Electronic Devices and Environments

### Electronic Device and Machine-Readable Media

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals-such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

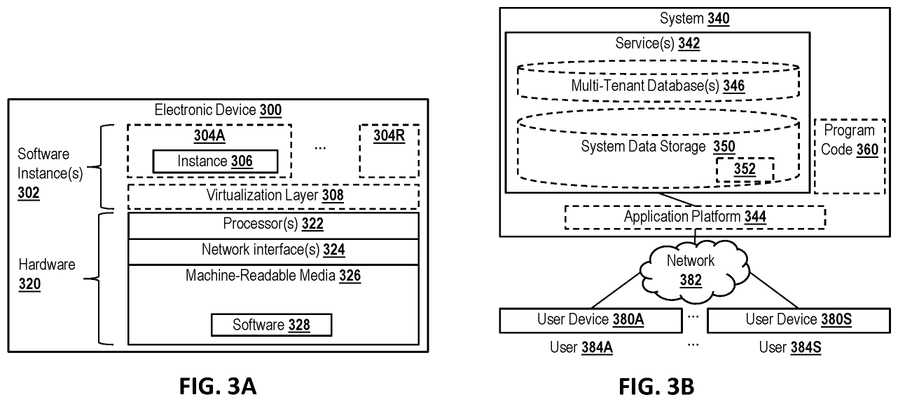

FIG. 3A is a block diagram illustrating an electronic device 300 according to some example implementations. FIG. 3A includes hardware 320 comprising a set of one or more processor(s) 322, a set of one or more network interfaces 324 (wireless and/or wired), and machine-readable media 326 having stored therein software 328 (which includes instructions executable by the set of one or more processor(s) 322). The machine-readable media 326 may include non-transitory and/or transitory machine-readable media. Each of the previously described instances 130A-C may be implemented in one or more electronic devices 300. In one implementation: each of the instances is implemented in a separate one of the electronic devices 300 (e.g., software 328 represents a web browser, a native client, a portal, a command-line interface, and/or an application programming interface (API) based upon protocols such as Simple Object Access Protocol (SOAP), Representational State Transfer (REST), etc.); and in operation, the electronic devices implementing the instances are communicatively coupled over a network or high speed interconnect fabric to one another and to the message broker 140 and/or database 160.

During operation, an instance of the software 328 (illustrated as instance 306 and referred to as a software instance; and in the more specific case of an application, as an application instance) is executed. In electronic devices that use compute virtualization, the set of one or more processor(s) 322 typically execute software to instantiate a virtualization layer 308 and one or more software container(s) 304A-304R (e.g., with operating system-level virtualization, the virtualization layer 308 may represent a container engine (such as Docker Engine by Docker, Inc. or rkt in Container Linux by Red Hat, Inc.) running on top of (or integrated into) an operating system, and it allows for the creation of multiple software containers 304A-304R (representing separate user space instances and also called virtualization engines, virtual private servers, or jails) that may each be used to execute a set of one or more applications; with full virtualization, the virtualization layer 308 represents a hypervisor (sometimes referred to as a virtual machine monitor (VMM)) or a hypervisor executing on top of a host operating system, and the software containers 304A-304R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 328 is executed within the software container 304A on the virtualization layer 308. In electronic devices where compute virtualization is not used, the instance 306 on top of a host operating system is executed on the “bare metal” electronic device 300. The instantiation of the instance 306, as well as the virtualization layer 308 and software containers 304A-304R if implemented, are collectively referred to as software instance(s) 302.

Alternative implementations of an electronic device may have numerous variations from that described above. For example, customized hardware and/or accelerators might also be used in an electronic device.

### Example Environment

FIG. 3B is a block diagram of a deployment environment according to some example implementations. A system 340 includes hardware (e.g., a set of one or more server devices) and software to provide service(s) 342, including the pricing service. In some implementations the system 340 is in one or more datacenter(s). These datacenter(s) may be: 1) first party datacenter(s), which are datacenter(s) owned and/or operated by the same entity that provides and/or operates some or all of the software that provides the service(s) 342; and/or 2) third-party datacenter(s), which are datacenter(s) owned and/or operated by one or more different entities than the entity that provides the service(s) 342 (e.g., the different entities may host some or all of the software provided and/or operated by the entity that provides the service(s) 342). For example, third-party datacenters may be owned and/or operated by entities providing public cloud services (e.g., Amazon.com, Inc. (Amazon Web Services), Google LLC (Google Cloud Platform), Microsoft Corporation (Azure)).

The system 340 is coupled to user devices 380A-380S over a network 382. The service(s) 342 may be on-demand services that are made available to one or more of the users 384A-384S working for one or more entities other than the entity which owns and/or operates the on-demand services (those users sometimes referred to as outside users) so that those entities need not be concerned with building and/or maintaining a system, but instead may make use of the service(s) 342 when needed (e.g., when needed by the users 384A-384S). The service(s) 342 may communicate with each other and/or with one or more of the user devices 380A-380S via one or more APIs (e.g., a REST API). In some implementations, the user devices 380A-380S are operated by users 384A-384S, and each may be operated as a client device and/or a server device. In some implementations, one or more of the user devices 380A-380S are separate ones of the electronic device 300 or include one or more features of the electronic device 300.

In some implementations, the system 340 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 340 is a multi-tenant cloud computing architecture supporting multiple services, such as one or more of the following types of services: Pricing; Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Cache-as-a-Service (CaaS); Analytics; Community; Internet-of-Things (IoT); Industry-specific; Artificial intelligence (AI); Application marketplace (“app store”); Data modeling; Security; and Identity and access management (IAM).

For example, system 340 may include an application platform 344 that enables PAAS for creating, managing, and executing one or more applications developed by the provider of the application platform 344, users accessing the system 340 via one or more of user devices 380A-380S, or third-party application developers accessing the system 340 via one or more of user devices 380A-380S.

In some implementations, one or more of the service(s) 342 may use one or more multi-tenant databases 346, as well as system data storage 350 for system data 352 accessible to system 340. In certain implementations, the system 340 includes a set of one or more servers that are running on server electronic devices and that are configured to handle requests for any authorized user associated with any tenant (there is no server affinity for a user and/or tenant to a specific server). The user devices 380A-380S communicate with the server(s) of system 340 to request and update tenant-level data and system-level data hosted by system 340, and in response the system 340 (e.g., one or more servers in system 340) automatically may generate one or more Structured Query Language (SQL) statements (e.g., one or more SQL queries) that are designed to access the desired information from the multi-tenant database(s) 346 and/or system data storage 350.

In some implementations, the service(s) 342 are implemented using virtual applications dynamically created at run time responsive to queries from the user devices 380A-380S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 360 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. In some implementations, the program code 360 may form at least a portion of the scale-mode pricing runtime 700, which provides the execution environment for the pricing service 120A, asynchronous pricing service 1500, instances of the pricing engines 115A, and various other system components described above. Further, in one implementation, the application platform 344 includes an application setup mechanism that supports application developers' creation and management of applications, which may be saved as metadata by save routines. Invocations to such applications, including the pricing service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 382 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 340 and the user devices 380A-380S.

Each user device 380A-380S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 340. For example, the user interface device can be used to access data and applications hosted by system 340, and to perform searches on stored data, and otherwise allow one or more of users 384A-384S to interact with various GUI pages that may be presented to the one or more of users 384A-384S. User devices 380A-380S might communicate with system 340 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 380A-380S might include an HTTP client, commonly referred to as a “browser,” for sending and receiving HTTP messages to and from server(s) of system 340, thus allowing users 384A-384S of the user devices 380A-380S to access, process and view information, pages and applications available to it from system 340 over network 382.

### CONCLUSION

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. For example, while a single instance 130C is elected to perform the cluster wide health analysis in the embodiments described above, multiple instances, or all of the instances may perform the health analysis in parallel in other implementations. In addition, the underlying principles described herein are not limited to message passing and health analysis on application “instances” and instead may be implemented on any logical arrangement of functional software modules, including homogeneous and heterogeneous modules. Furthermore, the specific instances architectures shown in FIG. 1 are not required for complying with the underlying principles of the invention.

What is claimed is:

1. An article of manufacture comprising a non-transitory machine-readable storage medium that provides instructions that, if executed by one or more electronic devices are configurable to cause the one or more electronic devices to perform operations comprising:
responsive to one or more resource utilization thresholds being reached, analyzing metering data from a plurality of application instances of an application cluster to identify a particular message type of a plurality of message types or a particular message type and entity combination that is responsible, at least in part, for the one or more resource utilization thresholds being reached, wherein the metering data includes resource utilization by message type resulting from processing messages of different ones of the plurality of message types by the plurality of application instances using a plurality of resources of the application cluster, wherein processing messages of at least some of the plurality of message types uses different sets of the plurality of resources; and
responsive to the identification of the particular message type or the particular message type and entity combination, automatically causing one or more remediation actions to alter processing of messages of the particular message type on the plurality of application instances.

2. The article of manufacture of claim 1 wherein the one or more remediation actions comprises throttling messages of the particular message type.

3. The article of manufacture of claim 1 wherein the entity comprises a tenant.

4. The article of manufacture of claim 1 wherein analyzing the metering data is performed on a first application instance of the application cluster using the metering data provided, at least in part, from other application instances in the application cluster.

5. The article of manufacture of claim 4 comprising instructions that, if executed by one or more electronic devices are configurable to cause the one or more electronic devices to perform operations comprising:
selecting the first application instance for the analyzing the metering data dynamically at runtime.

6. The article of manufacture of claim 5 wherein the selecting is to be performed, at least in part, by the other application instances and/or the first application instance.

7. The article of manufacture of claim 1 wherein causing one or more remediation actions to alter processing of messages of the particular message type on the plurality of application instances further comprises:
publish an event to be accessed by a remediation manager configured with a set of scripts, each script to indicate remediation steps to be taken based in response to a corresponding set of circumstances.

8. The article of manufacture of claim 7 wherein the corresponding set of circumstances include an indication of a particular resource reaching the resource utilization threshold.

9. The article of manufacture of claim 7 wherein the event includes a plurality of indications including an indication of the resource that is saturated, an event time, an entity, and a message type.

10. The article of manufacture of claim 9 wherein one or more scripts of the set of scripts indicates an iterative set of remediation actions to be applied incrementally.

11. The article of manufacture of claim 10 wherein a least invasive remediation action is to be applied first, the remediation manager to wait a configurable amount of time and to apply a more invasive remediation action if a resource is still operating above the one or more resource utilization thresholds.

12. The article of manufacture of claim 11 wherein the remediation manager is to apply successively more invasive remediation actions until the resource is no longer operating above the one or more resource utilization thresholds.

13. The article of manufacture of claim 12 wherein the remediation manager is to transmit a notification to an entity responsible for the message type.

14. The article of manufacture of claim 4 wherein automatically performing the one or more remediation actions comprises the first application instance transmitting remediation commands to the other application instances in the application cluster, wherein the other application instances and the first application instance are to alter processing of messages of the particular message type.

15. A method implemented in a set of one or more electronic devices, the method comprising:
responsive to one or more resource utilization thresholds being reached, analyzing metering data from a plurality of application instances of an application cluster to identify a particular message type of a plurality of message types or a particular message type and entity combination that is responsible, at least in part, for the one or more resource utilization thresholds being reached, wherein the metering data includes resource utilization by message type resulting from processing messages of different ones of the plurality of message types by the plurality of application instances using a plurality of resources of the application cluster, wherein processing messages of at least some of the plurality of message types uses different sets of the plurality of resources; and
responsive to the identification of the particular message type or the particular message type and entity combination, automatically causing one or more remediation actions to alter processing of messages of the particular message type on the plurality of application instances.

16. The method of claim 15 wherein the one or more remediation actions comprises throttling messages of the particular message type.

17. The method of claim 15 wherein the entity comprises a tenant.

18. The method of claim 15 wherein analyzing the metering data is performed on a first application instance of the application cluster using the metering data provided, at least in part, from other application instances in the application cluster.

19. The method of claim 18 further comprising:
selecting the first application instance for the analyzing the metering data dynamically at runtime.

20. The method of claim 19 wherein the selecting is to be performed, at least in part, by the other application instances and/or the first application instance.

21. The method of claim 15 wherein causing one or more remediation actions to alter processing of messages of the particular message type on the plurality of application instances further comprises:
publish an event to be accessed by a remediation manager configured with a set of scripts, each script to indicate remediation steps to be taken based in response to a corresponding set of circumstances.

22. The method of claim 21 wherein the corresponding set of circumstances include an indication of a particular resource reaching the resource utilization threshold.

23. The method of claim 21 wherein the event includes a plurality of indications including an indication of the resource that is saturated, an event time, an entity, and a message type.

24. The method of claim 23 wherein one or more scripts of the set of scripts indicates an iterative set of remediation actions to be applied incrementally.

25. The method of claim 24 wherein a least invasive remediation action is to be applied first, the remediation manager to wait a configurable amount of time and to apply a more invasive remediation action if a resource is still operating above the one or more resource utilization thresholds.

26. The method of claim 25 wherein the remediation manager is to apply successively more invasive remediation actions until the resource is no longer operating above the one or more resource utilization thresholds.

27. The method of claim 26 wherein the remediation manager is to transmit a notification to an entity responsible for the message type.

28. The method of claim 18 wherein automatically performing the one or more remediation actions comprises the first application instance transmitting remediation commands to the other application instances in the application cluster, wherein the other application instances and the first application instance are to alter processing of messages of the particular message type.
